(19) United States
(12) Patent Application Publication
(10) Pub. No.: US 2025/0254078 A1
(43) Pub. Date: Aug. 7, 2025

(54) DYNAMIC SWITCHING BETWEEN DFT-S-OFDM AND CP-OFDM

(71) Applicant: Mavenir Systems, Inc., Richardson, TX (US)

(72) Inventors: Jianying Liu, Beijing (CN); Fan Yang, Beijing (CN); Miao Zhang, Beijing (CN); Jingru Chen, Chengdu (CN)

(73) Assignee: Mavenir Systems, Inc., Richardson, TX (US)

(21) Appl. No.: 19/084,203

(22) Filed: Mar. 19, 2025

Related U.S. Application Data
(63) Continuation of application No. PCT/CN2022/120760, filed on Sep. 23, 2022.

(51) Int. Cl. H04L 27/26; H04L 5/00; H04W 72/21

(52) U.S. Cl. CPC H04L 27/2636; H04L 5/0007; H04L 5/0028; H04W 72/21

(57) ABSTRACT

There is provided a method of switching between Discrete Fourier Transform spread Orthogonal Frequency Division Multiplexing (DFT-S-OFDM) and Cyclic Prefix-Orthogonal Frequency Division Multiplexing (CP-OFDM) in a mobile communication system. The method is performed by a g NodeB (gNB), and includes (a) preparing a Medium Access Control (MAC) layer communication message that specifies which of DFT-S-OFDM or CP-OFDM will be used for an uplink (UL) waveform, and (b) dynamically transmitting the message to user equipment. There is also provided an apparatus that performs the method, and a storage device that contains instructions that cause a processor to perform the method.

### CROSS REFERENCE TO RELATED APPLICATIONS

The present application is a continuation application of International (PCT) application No. PCT/CN2022/120760 filed on Sep. 23, 2022 and is incorporated herein by reference in entirety.

### BACKGROUND OF THE DISCLOSURE

### 1. Field of the Disclosure

The present disclosure relates to mobile communications, and more particularly, to a joint use DFT-S-OFDM and CP-OFDM in a network.

Near the end of the present document, there is a list of acronyms and a list of definitions.

### 2. Description of the Related Art

The approaches described in this section are approaches that could be pursued, but not necessarily approaches that have been previously conceived or pursued. Therefore, the approaches described in this section may not be prior art to the claims in this application and are not admitted to be prior art by inclusion in this section.

Nowadays, 5G new radio (NR) is becoming more popular. It has unique features as compared to LTE, such as scalability OFDM and the diverse use cases (human-centric and machine-centric) beyond mobile broadband services.

5G NR PUSCH introduces two kinds of UL waveforms: DFT-S-OFDM and CP-OFDM.

CP-OFDM offers high spectral packing efficiency in Resource Blocks (RBs). It is employed when network operators need to maximize network capacity in dense urban environments. It can also be used for high throughput scenarios.

Compared with CP-OFDM, DFT-S-OFDM adds transform precoding after layer mapping. It offers less efficient spectral packing, but it is used to address greater range requirements. It can also be used for power limited scenarios.

Thus, DFT-S-OFDM and CP-OFDM waveforms both have advantages and disadvantages.

It is beneficial to joint-use DFT-S-OFDM and CP-OFDM in a network, for example, if a UE moves from cell center to cell edge, then it needs to switch from CP-OFDM to DFT-S-OFDM for the best performance, and if the UE moves back to cell center, it needs to switch back to CP-OFDM.

A gNB is responsible for deciding whether to change the waveform scheme of PUSCH, and for informing the UE of the change. In a prior art system, any change in the PUSCH waveform scheme can only be done by RRC reconfiguration. An RRC reconfiguration message and its reply message is built and decoded by an RRC layer, which results in a high latency. During a reconfiguration period, there is uncertainty on the network side about the waveform UE used currently, which may involve link interruption. As such, switching by RRC reconfiguration is effectively, or similar to, static switching.

Dynamic switching means the switching message involves shorter latency with less link interruption than the static switching by the RRC reconfiguration message. As the switching occurs when the UE is moving from cell center to cell edge or back from edge to center, a shorter latency and less link interruption would be very desirable especially for high-speed UE and cell edge UE.

The problem is that dynamic switching between DFT-S-OFDM and CP-OFDM is not presently supported in 3GPP.

As per the present 5G NR specification, CP-OFDM or DFT-S-OFDM is indicated by transformPrecoder, which involved in (or related to) RRC parameters configured in an RRC message (e.g., pusch-Config, configuredGrantConfig, msg3-transformPrecoder and msgA-TransformPrecoder-r16).

When transformPrecoder is included in pusch-Config or configuredGrantConfig, transformPrecoder enabled means using DFT-S-OFDM for PUSCH and transformPrecoder disabled means using CP-OFDM for PUSCH. If transformPrecoder is absent, the UE enables or disables transform precoding in accordance with the field msg3-transformPrecoder or msgA-TransformPrecoder-r16, as follows.

transformPrecoder ENUMERATED {enabled, disabled} OPTIONAL, --
Need S

| | |
|---|---|
| msg3-transformPrecoder | ENUMERATED {enabled} |

OPTIONAL, -- Need R

| | |
|---|---|
| msgA-TransformPrecoder-r16 | ENUMERATED {enabled, disabled} |

OPTIONAL, -- Need R

Now, the switching is by an RRC reconfigure message, which, as mentioned above, is similar to a static method. When gNB wants to change the PUSCH waveform, it needs to reconfigure RRC messages to UE, which results in a long latency. And because of the uncertainty on the network side during the RRC reconfiguration period, it may involve link interruption.

### SUMMARY OF THE DISCLOSURE

There is provided a method of switching between Discrete Fourier Transform spread Orthogonal Frequency Division Multiplexing (DFT-S-OFDM) and Cyclic Prefix-Orthogonal Frequency Division Multiplexing (CP-OFDM) in a mobile communication system. The method is performed by a g NodeB (gNB), and includes (a) preparing a Medium Access Control (MAC) layer communication message that specifies which of DFT-S-OFDM or CP-OFDM will be used for an uplink (UL) waveform, and (b) dynamically transmitting the message to user equipment. There is also provided an apparatus that performs the method, and a storage device that contains instructions that cause a processor to perform the method.

### BRIEF DESCRIPTION OF THE DRAWINGS

FIG. 1 is a block diagram of a system that provides dynamic switching between DFT-S-OFDM and CP-OFDM.

FIG. 2 shows the format of a UL Waveform Activation/Deactivation MAC CE in the system of FIG. 1, when the highest ServCellIndex of Serving Cell with configured uplink is less than 8.

FIG. 3 shows the format of a UL Waveform Activation/Deactivation MAC CE in the system of FIG. 1, when the highest ServCellIndex of Serving Cell with the configured uplink is equal to or greater than 8.

A component or a feature that is common to more than one drawing is indicated with the same reference number in each of the drawings.

### DESCRIPTION OF THE DISCLOSURE

The present document discloses two techniques that provides for dynamic switching between DFT-S-OFDM and CP-OFDM, namely, (1) by MAC CE, (2) by DCI.

As mentioned above, dynamic switching means the switching message involves shorter latency with less link interruption than the static switching by the RRC reconfiguration message. As the switching occurs when the UE is moving from cell center to cell edge or back from edge to center, a shorter latency and less link interruption would be very desirable especially for high-speed UE and cell edge UE.

MAC CE is a special MAC structure carrying control information, and is transmitted on the Physical Downlink Shared Channel or Physical Uplink Shared Channel. MAC CE is scheduled and built by the MAC layer.

The DCI transports downlink control information and is transmitted on the Physical Downlink Control Channel. DCI is scheduled and built by the MAC layer.

Compared with RRC messages generated and processed by the RRC layer, MAC CE or DCI messages are MAC layer communications, which would be much faster and easily decoded by UE and without any link interruption when gNB wants to change a PUSCH waveform between DFT-S-OFDM and CP-OFDM.

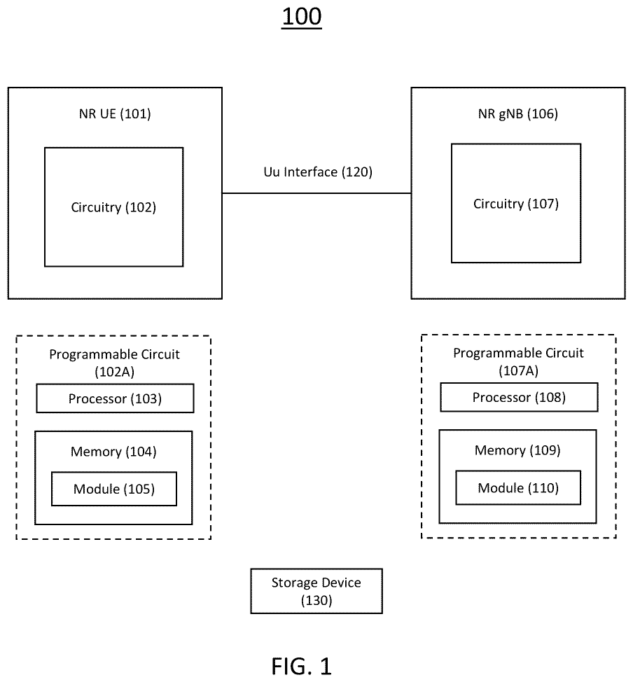

FIG. 1 is a block diagram of a system 100 that provides dynamic switching between DFT-S-OFDM and CP-OFDM. System 100 includes an NR UE 101 and an NR gNB 106. NR UE 101 and NR gNB 106 are communicatively coupled via a Uu interface 120.

NR UE 101 includes electronic circuitry, namely circuitry 102, that performs operations on behalf of NR UE 101 to execute methods described herein. Circuity 102 may be implemented with any or all of (a) discrete electronic components, (b) firmware, and (c) a programmable circuit 102A.

Programmable circuit 102A, which is an optional implementation of circuitry 102, includes a processor 103 and a memory 104. Processor 103 is an electronic device configured of logic circuitry that responds to and executes instructions. Memory 104 is a tangible, non-transitory, computer-readable storage device encoded with a computer program. In this regard, memory 104 stores data and instructions, i.e., program code, that are readable and executable by processor 103 for controlling operations of processor 103. Memory 104 may be implemented in a random-access memory (RAM), a hard drive, a read only memory (ROM), or a combination thereof. One of the components of memory 104 is a program module, namely module 105. Module 105 contains instructions for controlling processor 103 to execute operations described herein on behalf of NR UE 101.

NR gNB 106 includes electronic circuitry, namely circuitry 107, that performs operations on behalf of NR gNB 106 to execute methods described herein. Circuity 107 may be implemented with any or all of (a) discrete electronic components, (b) firmware, and (c) a programmable circuit 107A.

Programmable circuit 107A, which is an optional implementation of circuitry 107, includes a processor 108 and a memory 109. Processor 108 is an electronic device configured of logic circuitry that responds to and executes instructions. Memory 109 is a tangible, non-transitory, computer-readable storage device encoded with a computer program. In this regard, memory 109 stores data and instructions, i.e., program code, that are readable and executable by processor 108 for controlling operations of processor 108. Memory 109 may be implemented in a random-access memory (RAM), a hard drive, a read only memory (ROM), or a combination thereof. One of the components of memory 109 is a program module, namely module 110. Module 110 contains instructions for controlling processor 108 to execute operations described herein on behalf of NR gNB 106.

The term “module” is used herein to denote a functional operation that may be embodied either as a stand-alone component or as an integrated configuration of a plurality of subordinate components. Thus, each of module 105 and 110 may be implemented as a single module or as a plurality of modules that operate in cooperation with one another.

While module 110 is indicated as being already loaded into memory 109, module 110 may be configured on a storage device 130 for subsequent loading into memory 109. Storage device 130 is a tangible, non-transitory, computer-readable storage device that stores module 110 thereon. Examples of storage device 130 include (a) a compact disk, (b) a magnetic tape, (c) a read only memory, (d) an optical storage medium, (e) a hard drive, (f) a memory unit consisting of multiple parallel hard drives, (g) a universal serial bus (USB) flash drive, (h) a random-access memory, and (i) an electronic storage device coupled to NR gNB 106 via a data communications network.

Uu interface 120 is a radio link between NR UE 101 and NR gNB 106, and is compliant with the 5G NR specification.

As mentioned above, the present document discloses two techniques that provide dynamic switching between DFT-S-OFDM and CP-OFDM, namely (1) by MAC CE, and (2) by DCI. In brief, in these techniques, NR gNB 106 transmits MAC CE or DCI via Uu interface 120 to NR UE 101 to enable dynamic switching between DFT-S-OFDM and CP-OFDM.

### Dynamic Switching by MAC CE

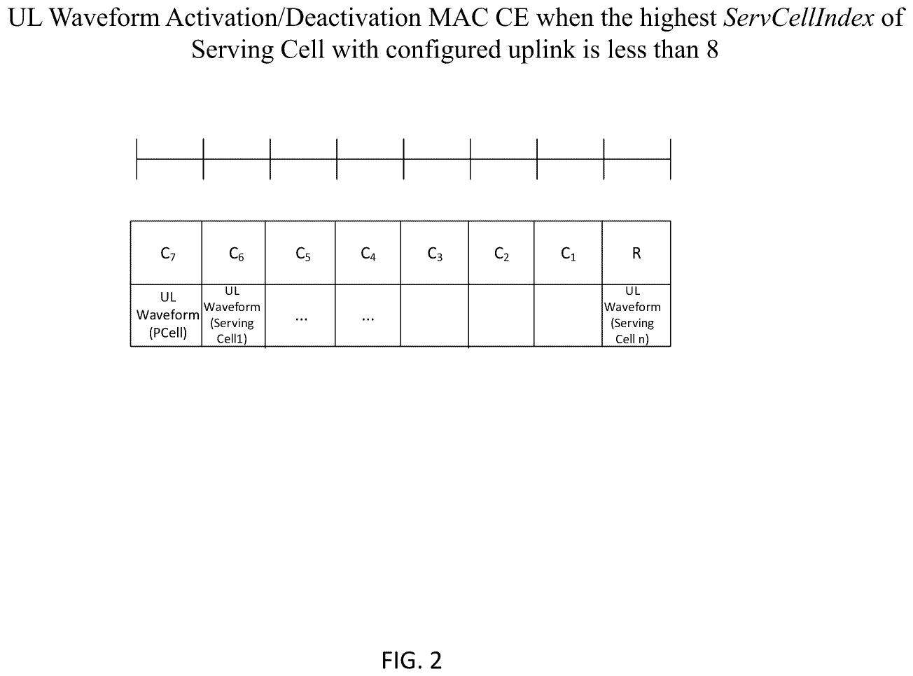

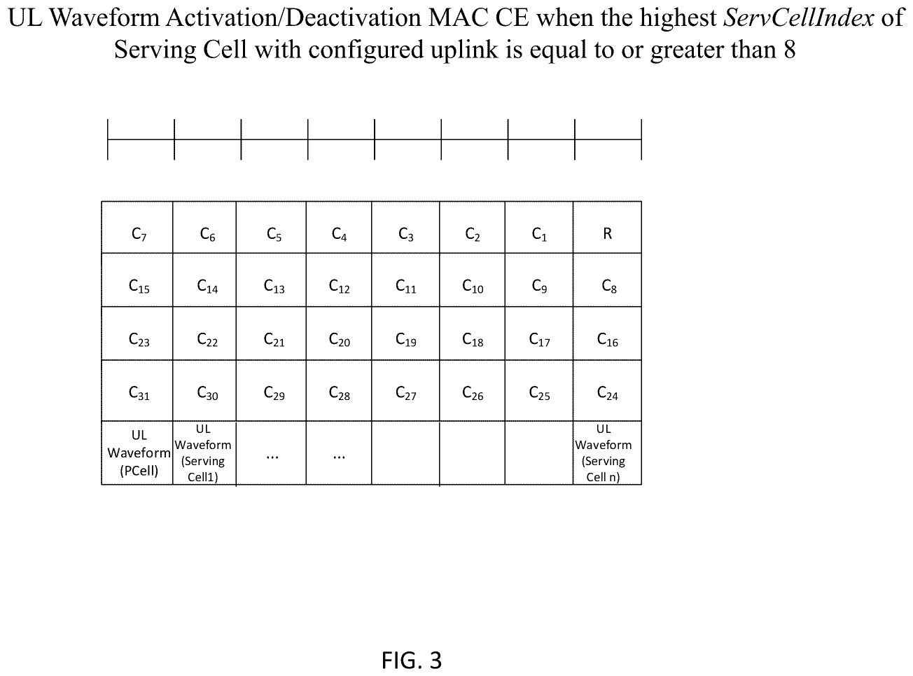

FIGS. 2 and 3 show formats of UL Waveform Activation/Deactivation MAC CE in system 100. FIG. 2 shows the format of a UL Waveform Activation/Deactivation MAC CE when the highest ServCellIndex of Serving Cell with configured uplink is less than 8. FIG. 3 shows the format of a UL Waveform Activation/Deactivation MAC CE when the highest ServCellIndex of Serving Cell with configured uplink is equal to or greater than 8.

The format in FIG. 2 is used for indicating the UL wave per Serving Cell when the highest ServCellIndex of Serving Cell with configured uplink is less than 8, otherwise, the format in FIG. 3 is used.

UL Waveform Activation/Deactivation MAC CE in FIG. 2 and FIG. 3 has a variable size, and the meaning of the fields are as follows:
Cᵢ: This field indicates the presence of a UL wave for the Serving Cell with ServCellIndex i. The Cᵢ field set to 1 indicates that a UL Waveform field for the Serving Cell with ServCellIndex i is present. The Cᵢ field set to 0 indicates that a UL Waveform field for the Serving Cell with ServCellIndex i is absent.
UL Waveform: This field indicates the type of UL waveform is CP-OFDM or DFT-S-OFDM. If UL waveform field is set to 0, the waveform type is CP-OFDM. If UL waveform is set to 1, the waveform type is DFT-s-OFDM, or vice versa.
R: Reserved bit, set to 0.

The UL Waveform Activation/Deactivation MAC CE of FIG. 2 and FIG. 3 should be identified by a LCID or eLCID of the MAC subheader. The present document discloses two options to identify the MAC CE of FIG. 2 or FIG. 3.

The first option is to use the Codepoint/Index 45 and 46 for identifying the UL Waveform Activation/Deactivation MAC CE, as shown in Table 1, below, in which Codepoint/Index 45 is used to identify the UL Waveform MAC CE of FIG. 2, and Codepoint/Index 46 is used to identify the UL Waveform MAC CE of FIG. 3. The values of Codepoint/Index are only examples, as other reserved values can be used.

The second option is to use the Codepoint 225-226 and Index 289-290 for UL Waveform Activation/Deactivation MAC CE, as shown in Table 2, below, in which Codepoint 225 and Index 289 are used to identify the UL Waveform MAC CE of FIG. 2, and Codepoint 226 and Index 290 are used to identify the UL Waveform MAC CE of FIG. 3. The values of Codepoint are only examples, other reserved values can be used.

TABLE 1
Values of LCID for DL-SCH

| Codepoint/ | |
|---|---|
| Index | LCID values |
| 0 | CCCH |
| 1-32 | Identity of the logical channel of DCCH, |
| | DTCH and multicast MTCH |
| 33 | Extended logical channel ID field |
| | (two-octet eLCID field) |
| 34 | Extended logical channel ID field |
| | (one-octet eLCID field) |
| 35-44 | Reserved |
| 45 | UL Waveform (one octet Cᵢ) |
| 46 | UL Waveform (four octet Cᵢ) |
| 47 | Recommended bit rate |
| 48 | SP ZP CSI-RS Resource Set Activation/Deactivation |
| 49 | PUCCH spatial relation Activation/Deactivation |
| 50 | SP SRS Activation/Deactivation |
| 51 | SP CSI reporting on PUCCH Activation/Deactivation |
| 52 | TCI State Indication for UE-specific PDCCH |
| 53 | TCI States Activation/Deactivation |
| | for UE-specific PDSCH |
| 54 | Aperiodic CSI Trigger State Subselection |
| 55 | SP CSI-RS/CSI-IM Resource Set |
| | Activation/Deactivation |
| 56 | Duplication Activation/Deactivation |
| 57 | SCell Activation/Deactivation (four octets) |
| 58 | SCell Activation/Deactivation (one octet) |
| 59 | Long DRX Command |
| 60 | DRX Command |
| 61 | Timing Advance Command |
| 62 | UE Contention Resolution Identity |
| 63 | Padding |

TABLE 2
Values of one-octet eLCID for DL-SCH

| Codepoint | Index | LCID values |
|---|---|---|
| 0 to 224 | 64 to 288 | Reserved |
| 225 | 289 | UL Waveform (one octet Cᵢ) |
| 226 | 290 | UL Waveform (four octet Cᵢ) |
| 227 | 291 | Serving Cell Set based SRS TCI |
| | | State Indication MAC CE |
| 228 | 292 | SP/AP SRS TCI State Indication MAC CE |
| 229 | 293 | BFD-RS Indication MAC CE |
| 230 | 294 | Differential Koffset |
| 231 | 295 | Enhanced SCell Activation/Deactivation |
| | | MAC CE with one octet Cᵢ field |
| 232 | 296 | Enhanced SCell Activation/Deactivation |
| | | MAC CE with four octet Cᵢ field |
| 233 | 297 | Unified TCI States Activation/Deactivation |
| | | MAC CE |
| 234 | 298 | PUCCH Power Control Set Update for |
| | | multiple TRP PUCCH repetition MAC CE |
| 235 | 299 | PUCCH spatial relation |
| | | Activation/Deactivation for |
| | | multiple TRP PUCCH repetition MAC CE |
| 236 | 300 | Enhanced TCI States Indication for |
| | | UE-specific PDCCH |
| 237 | 301 | Positioning Measurement Gap |
| | | Activation/Deactivation Command |
| 238 | 302 | PPW Activation/Deactivation Command |
| 239 | 303 | DL Tx Power Adjustment |
| 240 | 304 | Timing Case Indication |
| 241 | 305 | Child IAB-DU Restricted Beam Indication |
| 242 | 306 | Case-7 Timing advance offset |
| 243 | 307 | Provided Guard Symbols for Case-6 timing |
| 244 | 308 | Provided Guard Symbols for Case-7 timing |
| 245 | 309 | Serving Cell Set based SRS Spatial |
| | | Relation Indication |
| 246 | 310 | PUSCH Pathloss Reference RS Update |
| 247 | 311 | SRS Pathloss Reference RS Update |
| 248 | 312 | Enhanced SP/AP SRS Spatial |
| | | Relation Indication |
| 249 | 313 | Enhanced PUCCH Spatial Relation |
| | | Activation/Deactivation |
| 250 | 314 | Enhanced TCI States Activation/ |
| | | Deactivation for UE-specific PDSCH |
| 251 | 315 | Duplication RLC Activation/Deactivation |
| 252 | 316 | Absolute Timing Advance Command |
| 253 | 317 | SP Positioning SRS Activation/Deactivation |
| 254 | 318 | Provided Guard Symbols |
| 255 | 319 | Timing Delta |

### Dynamic Switching by DCI

UL waveform indicator to be added in DCI format 0_0 and 0_1.

UL waveform indicator: 1 bit according to Table 3 or Table 4.

TABLE 3
UL waveform indicator

| Value of UL waveform | |
|---|---|
| indicator | UL waveform |
| 0 | CP-OFDM |
| 1 | DFT-S-OFDM |

TABLE 4
UL waveform indicator

| Value of UL waveform | |
|---|---|
| indicator | UL waveform |
| 0 | DFT-S-OFDM |
| 1 | CP-OFDM |

In practice, circuitry 107 performs the configuration of fields in FIGS. 2 and 3, using Tables 1 through 4.

Thus, system 100 performs a method of switching between DFT-S-OFDM and CP-OFDM in a mobile communication system. The method is performed by NR gNB 106, and includes (a) preparing a MAC layer communication message that specifies which of DFT-S-OFDM or CP-OFDM will be used for a UL waveform, and (b) dynamically transmitting the message to NR UE 101. The switching may be achieved by MAC CE, or by DCI.

For dynamic switching by MAC CE, the message is a MAC CE that includes (a) a field that indicate a presence of an uplink waveform for a serving cell; and (b) a field that indicates whether the UL waveform is DFT-S-OFDM or CP-OFDM. The MAC CE is in a format that is used for indicating a UL wave per Serving Cell when a highest ServCellIndex of Serving Cell with a configured uplink is less than 8, or in a format that is used for indicating a UL wave per Serving Cell when a highest ServCellIndex of Serving Cell with a configured uplink is equal to or greater than 8. The message includes a MAC subheader having (a) an LCID value that identifies the MAC CE, or (b) an eLCID value that identifies the MAC CE.

For dynamic switching by DCI, the message is a DCI that includes a field that indicates whether the UL waveform is DFT-S-OFDM or CP-OFDM.

### Acronyms

3GPP: Third generation partnership project
5G: 5^{th} Generation
BS: Base Station
CAPEX: Capital Expenditure
CE: Control Element
COTS: Commercial off-the-shelf
C-plane: Control plane
CP-OFDM: Cyclic Prefix—Orthogonal Frequency Division Multiplexing
C-RAN: cloud radio access network
CU: Central unit
DCI: Downlink Control Information
DFT-S-OFDM: Discrete Fourier Transform (DFT) spread Orthogonal Frequency Division Multiplexing
DL: Downlink
DL-SCH: Downlink shared channel
DU: Distribution unit
eLCID: extended Logical Channel Identify
gNB: g NodeB (applies to NR)
LCID: Logic Channel Identify
LTE: Long-Term Evolution
MAC: Medium Access Control
NR: New Radio
O-DU: O-RAN Distributed Unit
OFDM: Orthogonal Frequency Division Multiplexing
OPEX: Operating Expense
O-RAN: Open RAN (Basic O-RAN specifications are prepared by the O-RAN alliance)
O-RU: O-RAN Radio Unit
PUSCH: Physical Uplink Share Channel
RLC: Radio Link Control
RRC: Radio Resource Control
RU: Radio Unit
UE: User Equipment
UL: Uplink
U-plane: User Plane
Uu interface: Air interface between UE and 5G NR RAN

### Definitions

Channel: A contiguous frequency range between lower and upper frequency limits.
C-plane: Control Plane: refers specifically to real-time control between O-DU and O-RU, and should not be confused with the UE's control plane
DL: DownLink: data flow towards the radiating antenna (generally on the LLS interface)
LLS: Lower Layer Split: logical interface between O-DU and O-RU when using a lower layer (intra-PHY based) functional split.
O-CU: O-RAN Control Unit-a logical node hosting PDCP, RRC, SDAP and other control functions
O-DU: O-RAN Distributed Unit: a logical node hosting RLC/MAC/High-PHY layers based on a lower layer functional split.
O-RU: O-RAN Radio Unit: a logical node hosting Low-PHY layer and RF processing based on a lower layer functional split. This is similar to 3GPP's “TRP” or “RRH” but more specific in including the Low-PHY layer (FFT/iFFT, PRACH extraction).
OTA: Over the Air
UL: UpLink: data flow away from the radiating antenna (generally on the LLS interface)
U-Plane: User Plane: refers to IQ sample data transferred between O-DU and O-RU

The techniques described herein are exemplary, and should not be construed as implying any limitation on the present disclosure. Various alternatives, combinations and modifications could be devised by those skilled in the art. For example, operations associated with the processes described herein can be performed in any order, unless otherwise specified or dictated by the operations themselves. The present disclosure is intended to embrace all such alternatives, modifications and variances that fall within the scope of the appended claims.

The terms “comprises” or “comprising” are to be interpreted as specifying the presence of the stated features, integers, operations or components, but not precluding the presence of one or more other features, integers, operations or components or groups thereof. The terms “a” and “an” are indefinite articles, and as such, do not preclude embodiments having pluralities of articles.

What is claimed is:

1. A method of switching between Discrete Fourier Transform spread Orthogonal Frequency Division Multiplexing (DFT-S-OFDM) and Cyclic Prefix-Orthogonal Frequency Division Multiplexing (CP-OFDM) in a mobile communication system, wherein the method is performed by a g NodeB (gNB), and comprises:
preparing a Medium Access Control (MAC) layer communication message that specifies which of DFT-S-OFDM or CP-OFDM will be used for an uplink (UL) waveform; and
dynamically transmitting said message to user equipment.

2. The method of claim 1, wherein said message is a MAC Control Element (MAC CE).

3. The method of claim 2, wherein said MAC CE includes:
(a) a field that indicate a presence of an uplink waveform for a serving cell; and
(b) a field that indicates whether said UL waveform is DFT-S-OFDM or CP-OFDM.

4. The method of claim 3, wherein said MAC CE is in a format that is used for indicating a UL wave per Serving Cell when a highest ServCellIndex of Serving Cell with a configured uplink is less than 8.

5. The method of claim 3, wherein said MAC CE is in a format that is used for indicating a UL wave per Serving Cell when a highest ServCellIndex of Serving Cell with a configured uplink is equal to or greater than 8.

6. The method of claim 2, wherein said message includes a MAC subheader having a logic channel identify (LCID) value that identifies said MAC CE.

7. The method of claim 2, wherein said message includes a MAC subheader having an extended logic channel identify (eLCID) value that identifies said MAC CE.

8. The method of claim 1, wherein said message is a Downlink Control Information (DCI).

9. The method of claim 8, wherein said DCI includes a field that indicates whether said UL waveform is DFT-S-OFDM or CP-OFDM.

10. A g NodeB (gNB) that enables switching between Discrete Fourier Transform spread Orthogonal Frequency Division Multiplexing (DFT-S-OFDM) and Cyclic Prefix-Orthogonal Frequency Division Multiplexing (CP-OFDM) in a mobile communication system, wherein said gNB comprises an electronic circuit that performs of operations of:
preparing a Medium Access Control (MAC) Layer communication message that specifies which of DFT-S-OFDM or CP-OFDM will be used for an uplink (UL) waveform; and
dynamically transmitting said message to user equipment.

11. The gNB of claim 10, wherein said message is a MAC Control Element (MAC CE).

12. The gNB of claim 11, wherein said MAC CE includes:
(a) a field that indicate a presence of an uplink waveform for a serving cell; and
(b) a field that indicates whether said UL waveform is DFT-S-OFDM or CP-OFDM.

13. The gNB of claim 12, wherein said MAC CE is in a format that is used for indicating a UL wave per Serving Cell when a highest ServCellIndex of Serving Cell with a configured uplink is less than 8.

14. The gNB of claim 12, wherein said MAC CE is in a format that is used for indicating a UL wave per Serving Cell when a highest ServCellIndex of Serving Cell with a configured uplink is equal to or greater than 8.

15. The gNB of claim 11, wherein said message includes a MAC subheader having a logic channel identify (LCID) value that identifies said MAC CE.

16. The gNB of claim 11, wherein said message includes a MAC subheader having an extended logic channel identify (eLCID) value that identifies said MAC CE.

17. The gNB of claim 10, wherein said message is a Downlink Control Information (DCI).

18. The gNB of claim 17, wherein said DCI includes a field that indicates whether said UL waveform is DFT-S-OFDM or CP-OFDM.

19. A non-transitory storage device comprising instructions that are readable by a processor to cause said processor to perform operations of:
preparing a Medium Access Control (MAC) layer communication message that specifies which of DFT-S-OFDM or CP-OFDM will be used for an uplink (UL) waveform; and
dynamically transmitting said message to user equipment.
